(19) United States
(12) Patent Application Publication
(10) Pub. No.: US 2010/0146961 A1
(43) Pub. Date: Jun. 17, 2010

(54) ENGINE USING BOUYANT ELEMENTS

(76) Inventor: Thomas A. Silva, Phoenix, AZ (US)

Correspondence Address: MARVIN A. GLAZER, 2141 E. HIGHLAND AVE, SUITE 155, PHOENIX, AZ, 85016, US

(21) Appl. No.: 12/333,684

(22) Filed: Dec. 12, 2008

(51) Int. Cl. F03B 17/04

(52) U.S. Cl. 60/495

(57) ABSTRACT

An engine includes a liquid reservoir and a wheel mounted for rotation about a central shaft. Float members are supported symmetrically about the wheel for rotational movement and for movement toward or away from the central shaft. Each float member is coupled with a diametrically opposed float member on an opposite side of the wheel by a connecting rod. A camming surface urges passing float members toward the central shaft, and simultaneously urges a diametrically opposed float member away from the central shaft. The wheel rotates as a result of an imbalance in the buoyant forces created by the float members. Magnetic forces can supplement the camming surface for moving the float members toward and away from the central shaft.

### BACKGROUND OF THE INVENTION

1. Field of the Invention

The present invention relates generally to engines for creating motive forces, and more particularly, to an engine using bouyant elements to create rotational motion.

2. Description of the Related Art

As we all know, demand for energy has been continuously increasing, while the world's supply of oil, gas, coal, and other conventional fuels is fixed. Moreover, engines that operate on hydrocarbon fuels (or electrical power derived from such hydrocarbon fuels) tend to pollute the air.

Others have attempted to harness the bouyant forces of flotation members within water. For example, in U.S. Pat. No. 3,907,454 to Punton, a number of air bladders are rotatably mounted between a pair of chain loops that travel over upper and lower sprockets. As each bladder reaches the lower sprocket, it is filled with compressed air through a valving system. As each bladder unit reaches its topmost position, air within the bladder unit is exhausted. The bladder units filled with compressed air have greater buoyancy than the bladder units that are not filled with compressed air, causing rotation of the device.

U.S. Pat. No. 4,054,031 to Johnson discloses a number of collapsible air buckets secured to a rotating belt supported between upper and lower rollers. An air discharge pipe mounted near the bottom roller discharges air into the water tank and inflates the lower bucket. The buoyancy created by the inflated buckets on one side of the apparatus causes the belt to rotate. A power take off is coupled to the upper roller for powering an electric generator.

In U.S. Pat. No. 4,326,132 to Bokel, a number of buckets are secured for rotation to a chain loop or wheel submerged in liquid. As each bucket passes a lowermost sprocket, compressed gas is injected into the bucket for creating buoyancy forces tending to rotate the loop of buckets. The air injected into each bucket is displaced by water as each bucket rotates around the upper sprocket.

U.S. Pat. No. 4,363,212 to Everett discloses collapsible buckets secured to endless chains supported by upper and lower rotatable sprockets. Gas is admitted to fill each bucket near the lower sprocket, and buoyancy forces cause the apparatus to rotate.

U.S. Pat. No. 4,407,130 to Jackson again discloses the use of endless chains rotatably supported over upper and lower sprockets and carrying a series of air-containing receptacles. Pressurized air is delivered into each receptacle as it reaches the lower end of its travel for creating buoyancy forces to rotate the assembly.

Using a somewhat different approach, U.S. Pat. No. 3,194,008 to Baumgartner discloses a prime mover operating on buoyancy forces and using a series of sealed float members arranged about the periphery of a rotating wheel. An imbalance is created in the buoyancy forces by providing a plenum formed by a shroud which is maintained free of any water by continuously pumping compressed air into the shroud. The float members passing within the water-free shroud do not create any buoyancy forces, and the float wheel therefore rotates.

Other devices known in the art purport to transfer air from one float member to another as the device is rotated. For example, in U.S. Pat. No. 3,412,482 to Kusmer, buoyancy elements are arranged about a rotating belt or wheel, and are formed by a bellows-like structure having a variable volume. A weight is secured to each bellows for collapsing the bellows and expelling the air therefrom during its downward travel. The patent states that the expelled air is transferred to one or more of the upwardly moving chambers, thereby creating a continuous buoyancy imbalance to keep the wheel rotating. Similarly, in U.S. Pat. No. 3,466,866 to Eschenfeld, a series of cam-operated valves selectively inflate and deflate four balloons supported on a wheel for creating buoyancy forces to rotate the wheel. Likewise, in U.S. Pat. No. 3,934,964 to Diamond, a number of cylinders are secured to a drive belt extending over upper and lower pulleys; each cylinder is provided with a sliding piston, and oppositely paired cylinders are interconnected by a tube so that air can be transferred from one cylinder to the opposing cylinder. Air within cylinders on the downwardly-moving side of the apparatus expel air into cylinders on the upwardly-moving side of the apparatus to create a buoyancy imbalance for rotating the assembly.

Those of the devices referenced above which rely upon a source of compressed air must use energy to pressurize such air. In addition, tubing or other conduits must be mounted in or through the liquid tank to supply such compressed air to the buckets, or other flotation members, as they begin their upward ascent. Those of the devices referenced above which transfer air between one or more flotation bladders require weights, complicated valves, and/or pistons in order to control the transfer of air between such bladders.

Accordingly, it is an object of the present invention to provide an engine that uses imbalances created in the bouyant forces of flotation elements to create a motive force, without the need for a source of compressed air.

It is another object of the present invention to provide such an engine that avoids the need for weights, valves, and/or pistons.

It is a further object of the present invention to provide such an engine that avoids the need to transfer air between one flotation element and another.

Yet another object of the present invention is to provide such an engine that can be constructed relatively easily and inexpensively.

These and other objects of the invention will become more apparent to those skilled in the art as the description of the present invention proceeds.

### SUMMARY OF THE INVENTION

Briefly described, and in accordance with a preferred embodiment thereof, the present invention relates to an engine that includes a reservoir containing a liquid. The liquid may be, but is not limited to, water. A wheel is mounted for rotation about a central axis within the liquid reservoir, the central axis extending substantially horizontally. In the preferred embodiments, a shaft is supported in the reservoir along the central axis, and the wheel is mounted for rotation about the shaft.

The aforementioned engine includes a number of float members supported by the wheel within the liquid for rotational movement about the central axis; each of the float members is buoyant within the liquid. The float members are supported by the wheel in a manner which allows such float members to move generally toward or away from the central axis. The float members are spaced generally symmetrically about the wheel. In the preferred embodiment, the number of such float members is an even number, and each such float member is coupled with a diametrically opposed float member disposed on an opposite side of the wheel. In one preferred embodiment, two opposing float members are secured to opposing ends of an elongated rod that extends generally diametrically through the wheel; the elongated rod is slidingly supported by the wheel for movement generally along a slide axis that passes generally diametrically through the wheel. In this preferred embodiment, the elongated rod is supported by the wheel for both rotational movement about the central axis, as well as for sliding movement along the slide axis.

A camming surface is disposed proximate to a portion of the wheel for engaging float members that pass proximate to the camming surface. As each float member passes proximate to the camming surface, the camming surface urges each such float member to move generally toward the central axis, and simultaneously urges a diametrically opposed float member to move generally away from the central axis. In one preferred embodiment of the invention, this camming surface is a ramp. In an alternate embodiment, the camming surface includes one or more depression wheels.

The engine is designed to rotate as a result of an imbalance in the buoyant forces created by the various float members. The float member, or float members, that are displaced further from the central axis (i.e., the “extended float members”) each have a relatively longer effective lever arm about the central axis as compared with their opposing float members disposed on the opposite side of the wheel (i.e., the “retracted float members”). Accordingly, the upward bouyant forces exerted by the extended float members exert a greater rotational torque upon the wheel than do the opposing retracted float members, thereby urging the wheel to rotate.

In the preferred embodiment, the liquid in the reservoir has an upper surface, and each of the float members extends at least partially through and above the upper surface of the liquid as each float member rotates to a position directly above the central axis. depression wheels.

In an alternate embodiment of the present invention, the movement of the float members toward and away from the central axis is achieved by mounting the float members for pivotal movement to the periphery of the wheel about an eccentric axis, and selectively rotating each float member about its eccentric axis toward or away from the central axis. Preferably, a coupling rod connects opposing pairs of such float members to each other for synchronized movement. As one of the paired float members engages the camming surface, one of the paired float members pivots toward the central axis, and the opposing float member simultaneously pivots away from the central axis.

In yet another embodiment of the present invention, magnetic forces supplement the camming surface for moving the float members toward and away from the central axis. In this embodiment, each of the plurality of float members has a first magnetic polarity. A first magnet, of the first magnetic polarity, is disposed generally above the wheel for repelling each of the float members as it passes the first magnet. Preferably, a second magnet of a second opposing magnetic polarity is disposed generally below the wheel for attracting each of the plurality of float members as they pass the second magnet.

### BRIEF DESCRIPTION OF THE DRAWINGS

FIG. 1 is a perspective view of an engine including a wheel, a series of sliding float members, and a camming ramp, constructed in accordance with a first embodiment of the present invention.

FIG. 1A is an enlarged view of two opposing float members shown in FIG. 1 connected by a rod that is slidingly supported through a sleeve.

FIG. 2 is a front view of the engine shown in FIG. 1.

FIG. 3 is a front view of an alternate embodiment of the invention using a series of float members eccentrically pivoted to a wheel, and depression wheels in lieu of a camming ramp.

FIG. 4 is a front view of another embodiment of the invention wherein magnetic forces assist in shifting the positions of the float members.

FIG. 5 is a front view of a further embodiment of the present invention wherein sliding tubular members serve as flotation elements.

FIG. 5A is a partial perspective view of one of the sliding rods shown in FIG. 5.

### DETAILED DESCRIPTION OF THE PREFERRED EMBODIMENTS

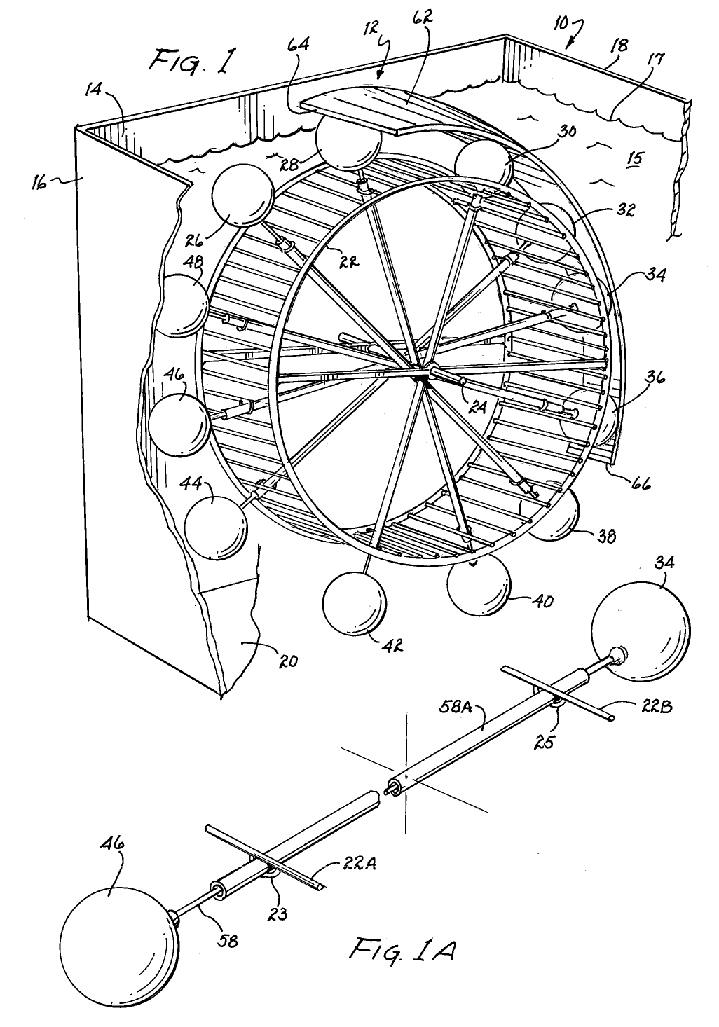

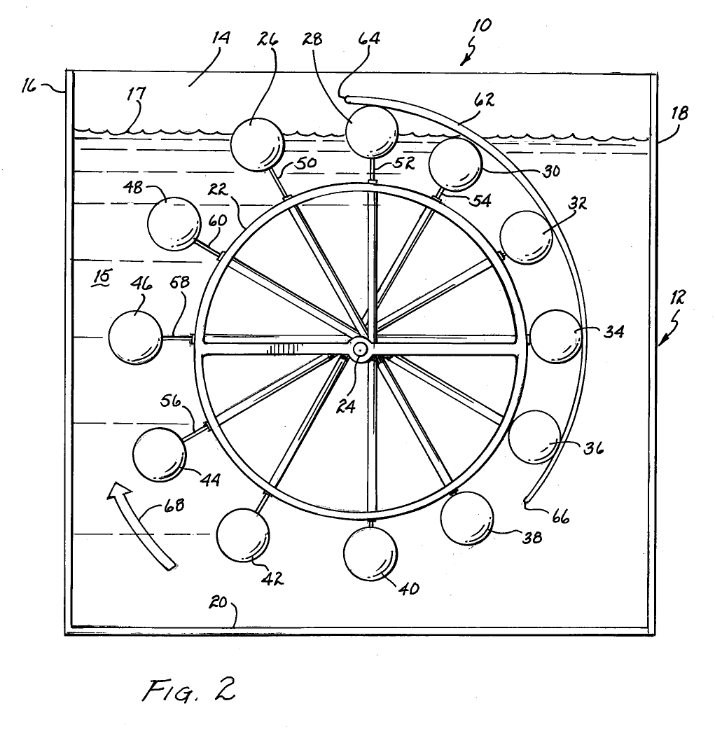

Referring to FIGS. 1 and 2, an engine 10 includes a tank or reservoir 12 for containing water or another liquid. Tank 12 includes a rear wall 14, two opposing side walls 16 and 18, a bottom wall 20, and a front wall (not shown) opposite rear wall 14. Tank 12 holds water or another liquid 15, the upper surface of which is designated by reference numeral 17. Other fluids which may be used apart from water include oils and salt water. If water is selected as the liquid 15, a layer of oil may be added, if desired, to float upon the upper surface 17 of water 15 to help lubricate moving parts. Tank 12 may be made of any suitable water-tight, non-corrosive material, including for example, glass or glazed ceramic.

A wheel 22 is mounted for rotation within tank 12. Wheel 22 includes a central shaft 24 for rotation about a central axis that extends substantially horizontal. While not shown in the drawings, the opposing ends of shaft 24 can be supported by bearing surfaces supported on the front wall (not shown) and rear wall 14 of tank 12 for allowing wheel 22 to freely rotate about its central axis. As shown best in FIG. 1, wheel 22 may be provided in the form of a wire cage structure, similar to a “hamster wheel”. Wheel 22 may be made of any durable, non-corrosive material.

Still referring to FIGS. 1 and 2, a series of float members, including floats 26, 28, 30, 32, 34, 36, 38, 40, 42, 44, 46, and 48, are movably supported by wheel 22 within liquid 15. Each of the float members 26-48 are buoyant within the liquid 15. Within the embodiment shown in FIGS. 1 and 2, float members 26-48 are each sealed capsules of air; such capsules may be made of plastic, metal, glass, glazed ceramic, or other suitable materials. Wheel 22 supports float members 26-48 for rotational movement about central shaft 24.

In addition, each such float member is secured to an end of a sliding rod whereby each float member is coupled with a diametrically opposed float member disposed on an opposite side of wheel 22. For example, float members 26 and 38 are secured to the opposing ends of rod 50; float members 28 and 40 are secured to the opposing ends of rod 52; float members 30 and 42 are secured to the opposing ends of rod 54; float members 32 and 44 are secured to the opposing ends of rod 56; float members 34 and 46 are secured to the opposing ends of rod 58; and float members 36 and 48 are secured to the opposing ends of rod 60. Ideally, rods 50-60, and the float members 26-48 attached thereto, are spaced generally symmetrically about wheel 22. Preferably, the upper surface 17 of liquid 15 is maintained at a height wherein each of float members 26-48 extends at least partially through upper surface 17 when each such float member rotates to a position directly above central shaft 24.

Each of the rods 50-60 is of a length that is greater than the diameter of wheel 22. In addition, each of the rods 50-60 is supported for sliding movement through wheel 22 along a generally diametrical path. In the preferred embodiment, rods 50-60 do not actually pass through central shaft 24, but extend proximate thereto. Rods 50-60 are preferably formed of a non-corrosive metal.

If desired, wheel 22 may include hollow tubular sleeves, one for each of rods 50-60, in which rods 50-60 can slide back and forth. For example, as shown in FIG. 1A, float members 34 and 46 are secured to the opposing ends of sliding rod 58. An outer sleeve 58A is secured proximate opposite ends to wheel portions 22A and 22B, as by retaining loops 23 and 25, respectively.

As each sliding rod moves along its diametrical axis, one of its float members moves toward central shaft 24, and that other of its float members moves away from central shaft 24. Referring to rod 52, by way of example, as float member 28 moves inwardly toward central shaft 24, rod 52 slides and forces float member 40 (secured to the opposing end of rod 52) away from central shaft 24.

As shown in FIGS. 1 and 2, a camming ramp 62 is disposed proximate to a portion of wheel 22. Camming ramp 62 has a first end 64 near the top of wheel 22 and is spaced apart from the top of wheel 22 by a distance that corresponds to the amount by which a float member extends beyond wheel 22 when such float member is fully extended. Referring to the front view shown in FIG. 2, camming ramp 62 continues clockwise along the periphery of wheel 22 toward bottom end 66 through an arc of about 110 degrees to 135 degrees. As camming ramp 62 sweeps along such arc, the inner surface of camming ramp 62 moves progressively closer to the periphery of wheel 22 until the distance separating camming ramp 62 from the periphery of wheel 22 approaches the size of a float member.

As shown in FIGS. 1 and 2, as each float member rotates into engagement with first end 64 of camming ramp 62, such float member engages the inner surface of camming ramp 62. Camming ramp 62 urges each float member passing proximate thereto to move inward toward central shaft 24. Such inward movement simultaneously urges a diametrically opposed float member to move outwardly away from central shaft 24. Thus, for example, in the view shown in FIGS. 1 and 2, float member 46 is extended away from central shaft 24, while opposing float member 34 is retracted inwardly toward central shaft 24. While float member 46 and float member 34 exert the same upward bouyant force as each other, float member 46 acts over a longer lever arm, and exerts greater torque on wheel 22 than does float member 34. The resulting imbalance of forces urges wheel 22 to rotate in a clockwise direction, relative to FIG. 2, as indicated by large arrow 68.

Initially, wheel 22 is at rest. A force must first be applied to wheel 22 to start wheel 22 rotating. So long as frictional forces are minimized, the imbalance in the bouyancy forces created by float members 26-48 will keep wheel 22 rotating. In order to derive power from engine 10, central shaft 24 can be coupled to a power takeoff. For example, central shaft 24 may be coupled through appropriate gearing to drive an electrical generator.

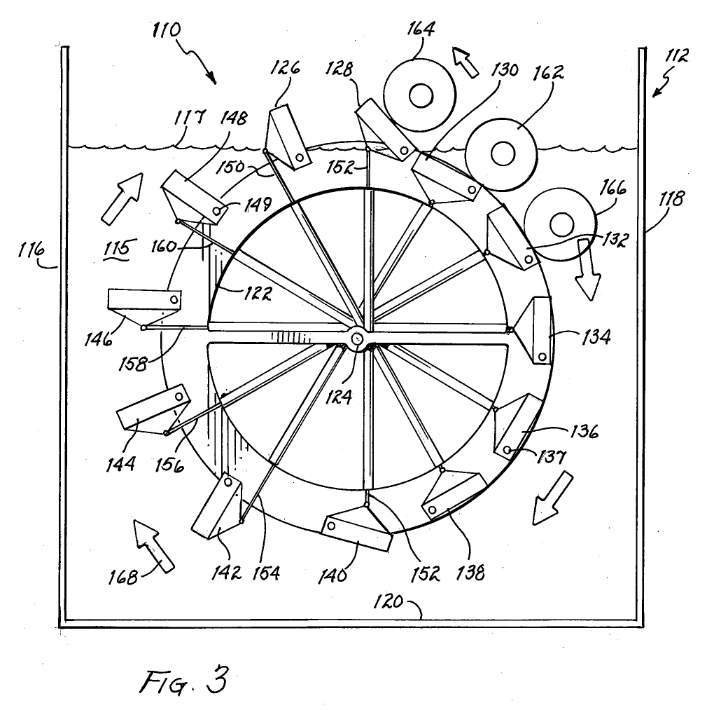

Turning now to FIG. 3, an alternate embodiment of the present invention is illustrated wherein the float members are each pivotally coupled to the wheel about an eccentric pivot axis. As in the prior embodiment, wheel 122 is supported for rotation about horizontal central shaft 124 within liquid tank 112. As before, tank 112 includes a rear wall (not shown), two opposing side walls 116 and 118, a bottom wall 120, and a front wall (not shown) opposite the rear wall. Tank 112 contains liquid 115 having an upper surface 117. Wheel 122 may include two spaced-apart circular plates with the float members disposed between and supported by such spaced-apart plates.

As shown in FIG. 3, a series of pivoting float members, including floats 126, 128, 130, 132, 134, 136, 138, 140, 142, 144, 146, and 148, are pivotally secured to, and supported by, wheel 122 within liquid 115. Each float member is pivotally secured to wheel 122 about an eccentric pivot axis. The eccentric pivot axis of float 136 is designated by reference numeral 137, and the eccentric pivot axis of diametrically-opposed float 148 is designated by reference numeral 149. Because the float members pivot about an eccentric pivot axis, the float members can assume a retracted position inside wheel 122, as represented by float member 136 in FIG. 3, or an extended position protruding from wheel 122, as represented by float member 148 in FIG. 3. Each of the float members 126-148 are buoyant within the liquid 115. Within the embodiment shown in FIG. 3, float members 126-148 are each sealed capsules of air. Wheel 122 supports float members 126-148 for rotational movement about central shaft 124.

In addition, each such float member is pivotally secured to an end of a sliding rod whereby each float member is coupled with a diametrically opposed float member disposed on an opposite side of wheel 122. For example, float members 126 and 138 are pivotally secured to the opposing ends of rod 150; float members 128 and 140 are pivotally secured to the opposing ends of rod 152; float members 130 and 142 are pivotally secured to the opposing ends of rod 154; float members 132 and 144 are pivotally secured to the opposing ends of rod 156; float members 134 and 146 are pivotally secured to the opposing ends of rod 158; and float members 136 and 148 are pivotally secured to the opposing ends of rod 160. Ideally, rods 150-160, and the float members 126-148 attached thereto, are spaced generally symmetrically about wheel 122. Preferably, the upper surface 117 of liquid 115 is maintained at a height wherein each of float members 126-148 extends at least partially through upper surface 17 when each such float member approaches the uppermost position of its travel.

Each of the rods 150-160 is of a predetermined length; the predetermined length of such rods is selected such that a float that is urged inside wheel 122 pushes its rod to extend the diametrically opposed float out of wheel 122. For example, float 130 is shown being urged within wheel 122, generally toward central shaft 124. Accordingly, rod 154, which is pivotally secured to float 130, pushes opposing float 142 to its fully-extended position out of wheel 122, and generally away from central shaft 124.

Still referring to FIG. 3, a series of three depression wheels 164, 162, and 166 take the place of camming ramp 62 in the prior embodiment. Depression wheels 164, 162, and 166 are disposed proximate to an upper portion of wheel 122 and serve to engage each float member as it passes over the top of wheel 122. As each float member rotates into engagement with first depression wheel 164, such float member begins to pivot to its retracted position within wheel 122 generally toward central shaft 24. Such inward movement simultaneously urges the upper end of rod 152 downward toward central shaft 124, moves the lower end of rod 152 downward and away from central shaft 124, and causes diametrically-opposed float member 140 to move outwardly away from central shaft 124 toward its extended position. While float member 146 and opposing float member 134 exert the same upward bouyant force as each other, float member 146 acts over a longer lever arm, and exerts greater torque on wheel 122 than does float member 134. The resulting imbalance of forces urges wheel 122 to rotate in a clockwise direction, relative to FIG. 3, as indicated by large arrow 168.

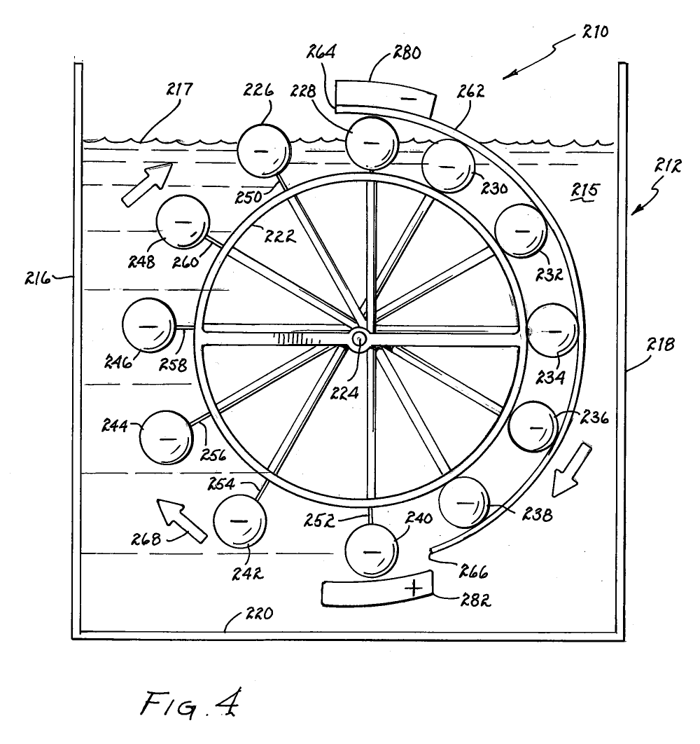

FIG. 4 illustrates an alternate embodiment of the present invention similar to that described above in regard to FIGS. 1 and 2 but utilizing magnetic forces to assist in sliding the float elements to their desired positions. Wheel 222 rotates about central shaft 224. Float members 226-248 and sliding rods 250-260 are disposed about wheel 222 in the same manner previously described in regard to the embodiment of the invention shown in FIGS. 1 and 2. Camming ramp 262 operates in generally the same manner as camming ramp 62 already described above. However, each of the float members 226-248 either incorporates a magnet or is made of a material that may be magnetized with a first magnetic polarity. The term “first magnetic polarity” is used herein to designate either the North pole or South pole of a magnet. For example, each float member may surround a bar magnet having its North pole directed inwardly toward central shaft 224 and its South pole directed outwardly away from central shaft 224.

A first fixed magnet, or fixed electromagnetic field, 280, is provided above wheel 212 proximate to, or within, first end 264 of camming ramp 262, and having the same magnetic polarity as float members 226-248, for repelling each of float members 226-248 as they rotate past first magnet 280. First magnet 280 is preferably disposed just past the top-dead-center position of each float member, and urges each passing float member to move radially inward even before making physical contact with camming ramp 262. If desired, magnet 280 may be extended downwardly along ramp 262 to approximately the height of shaft 224 to continue repelling float members passing proximate thereto; in this regard, magnet 280 could either be lengthened, or a series of such magnets of like polarity could be secured in series along ramp 262, from upper end 264 down to approximately the height of shaft 224.

A second fixed magnet, or fixed electromagnetic field, 282 is provided below wheel 212 approximately diametrically opposite (relative to central shaft 224) to first magnet 264, and having the opposite magnetic polarity as float members 226-248 for attracting each of float members 226-248 as they rotate past second magnet 282. Second magnet 282 urges each passing float member to move radially outward toward second magnet 282, thereby pulling the diametrically opposite float member radially inward toward central shaft 224. Once again, the imbalance in bouyant forces created by float members 226-248 creates a net torque on central shaft 224 tending to rotate wheel 212 in the clockwise direction (relative to FIG. 4), as indicated by arrow 268.

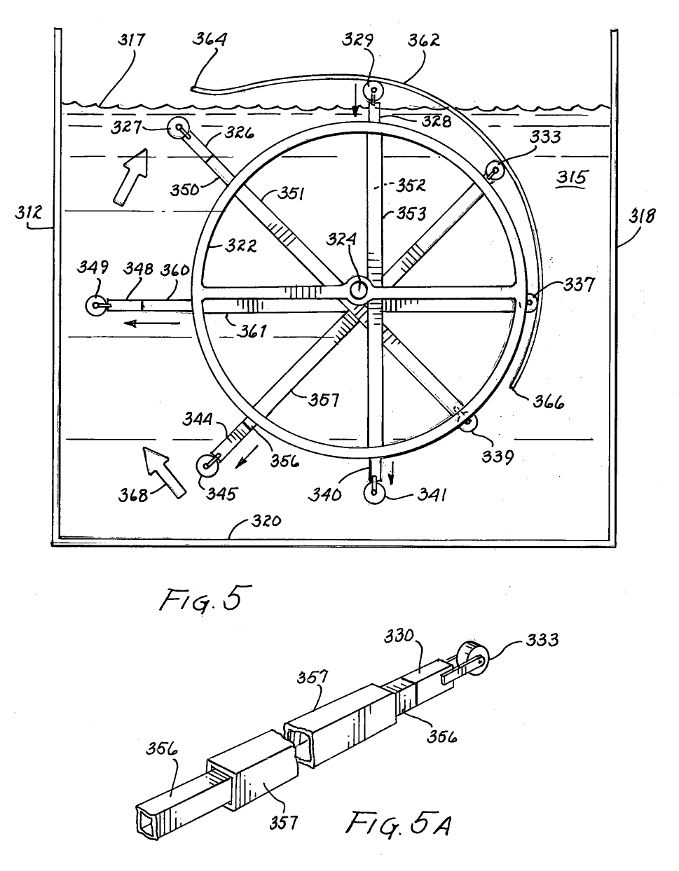

FIG. 5 illustrates an engine 310 constructed in accordance with yet another embodiment of the present invention generally similar to the first embodiment described in FIGS. 1 and 2 but incorporating float members within the opposing ends of tubular slide rods. Wheel 322 is mounted in liquid tank 312 for rotation about central shaft 324. Tank 312 includes side walls 316 and 318, bottom wall 320, rear wall 314 and a front wall (not shown). Tank 312 contains liquid 315 which has an upper surface 317. Wheel 322 includes four tubular sleeves 351, 353, 357 and 361 each extending generally diametrically relative to wheel 322. Tubular sleeves 351, 353, 357 and 361 are fixedly secured to wheel 322 and angularly spaced from each other at 45 degree intervals.

Four tubular sliding rods 350, 352, 356 and 360 extend within the aforementioned sleeves 351, 353, 357 and 361, respectively, and are free to move back and forth within such sleeves. Flotation members are formed within the opposing ends of each sliding rod. For example, sliding rod 352 has a first flotation member 328 formed in one of its ends, and a second flotation member 340 in its opposing end. Likewise, one end of sliding rod 350 includes flotation member 326; one end of sliding rod 356 includes flotation member 344; and one end of sliding rod 360 includes flotation member 348. Such flotation members can be formed, for example, by including a sealing wall recessed within each end of such sliding rod, the sealing wall being spaced somewhat apart from the end of such rod; the volume formed between each end of the rod and its associated sealing wall is charged with air and thereafter sealed at its end.

If desired, rollers may be provided on each of the ends of the sliding rods. As shown in FIG. 5, rod 350 includes opposing rollers 327 and 339. Likewise, rod 352 includes opposing rollers 329 and 341; rod 356 includes opposing rollers 333 and 345; and rod 360 includes opposing rollers 337 and 349.

As wheel 322 rotates in a clockwise direction (relative to FIG. 5), the upper end of each sliding rod approaches first end 364 of camming ramp 362. As shown in FIG. 5, roller 329 on the upper end of sliding rod 352 engages the inner camming surface of camming ramp 362, urging sliding rod 352 downward through outer sleeve 353, wherein opposing flotation members 328 and 340 extend approximately the same distance as each other from wheel 322. As further shown in FIG. 5, roller 333 has urged its associated end of sliding rod 356 even further into wheel 322, wherein flotation member 344 is almost fully-extended from wheel 322. In the case of sliding rod 360, by the time that roller 337 approaches the lower end 366 of camming ramp 362, flotation member 348 has been fully-extended from wheel 322. Once again, the resulting imbalance of bouyancy forces urges wheel 322 to rotate in a clockwise direction, relative to FIG. 5, as indicated by large arrow 368.

In the preferred embodiment, tubular sliding rods 350-360 have a non-circular cross-section, and support sleeves 351-361 likewise have a non-circular cross-section; in this manner, sliding rods 350-360 are prevented from twisting about their respective longitudinal axes, and rollers 327-349 are prevented from twisting about such longitudinal axes. Referring briefly to FIG. 5A, sliding rod 356 has a square cross-section and slides within outer sleeve 357, which likewise has a square cross-section. Float member 330 is formed in one end of sliding rod 356, and roller 333 extends from float member 330.

While not specifically illustrated, those skilled in the art will understand that, if desired, two or more of the wheels [22 in FIGS. 1 and 2; 122 in FIG. 3; 222 in FIG. 4; and 322 in FIG. 5] of the same construction can be disposed side-by-side with each other on a common shaft so that such wheels turn in unison to multiply the forces created by a single wheel.

Those skilled in the art will now appreciate that an engine has been described using bouyant elements that will produce rotational motion. The disclosed engine uses imbalances created in the bouyant forces of flotation elements to create a motive force, without the need for a source of compressed air, and without requiring weights, valves, and/or pistons. The engine described herein does not require any transfer of air between one flotation element and another during operation. Moreover, the disclosed engine can be constructed relatively easily and inexpensively. While the present invention has been described with respect to preferred embodiments thereof, such description is for illustrative purposes only, and is not to be construed as limiting the scope of the invention. Various modifications and changes may be made to the described embodiments by those skilled in the art without departing from the true spirit and scope of the invention as defined by the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. Wheel apparatus comprising in combination:
a. a reservoir containing a liquid;
b. a wheel mounted for rotation within the reservoir, the wheel rotating about a central axis, the central axis extending substantially horizontally;
c. a plurality of float members movably supported by the wheel within the liquid for both rotational movement about the central axis, as well as for movement generally toward or away from the central axis, each of the plurality of float members being buoyant within the liquid, the plurality of float members being spaced generally symmetrically about the wheel;
d. each float member being coupled with a diametrically opposed float member disposed on an opposite side of the wheel;
e. each float member having a first magnetic polarity;
f. a fixed electro-magnet positioned generally above the wheel and having the same magnetic polarity as the plurality of float members for repelling each float member as each float member rotates past the fixed electro-magnet, and urging each passing float member to move radially inward.

13. The wheel apparatus recited in claim 12 wherein the liquid is water.

14. The wheel apparatus recited in claim 12 further including a shaft supported in the reservoir along the central axis, and the wheel being mounted for rotation about the shaft.

15. The wheel apparatus recited in claim 12 further comprising:
a. a first elongated rod extending between first and second opposing ends, the first elongated rod extending generally diametrically through the wheel and being slidingly supported by the wheel;
b. a first of the plurality of float members being coupled to the first end of the first elongated rod; and
c. a second of the plurality of float members being coupled to the second end of the first elongated rod.

16. The wheel apparatus recited in claim 12 wherein the liquid in the reservoir has an upper surface, and wherein each of the plurality of float members extends at least partially through the upper surface of the liquid when each such float member is disposed directly above the central axis.

17. Wheel apparatus comprising in combination:
a. a reservoir containing a liquid;
b. a wheel mounted for rotation within the reservoir, the wheel rotating about a central axis, the central axis extending substantially horizontally;
c. a plurality of float members movably supported by the wheel within the liquid for both rotational movement about the central axis, as well as for movement generally toward or away from the central axis, each of the plurality of float members being buoyant within the liquid, the plurality of float members being spaced generally symmetrically about the wheel;
d. each float member being coupled with a diametrically opposed float member disposed on an opposite side of the wheel;
e. each float member having a first magnetic polarity;
f. a fixed electro-magnet positioned generally below the wheel and having the opposite magnetic polarity as the plurality of float members for attracting each float member as each float member rotates past the fixed electro-magnet, and urging each passing float member to move radially outward.

18. The wheel apparatus recited in claim 17 wherein the liquid is water.

19. The wheel apparatus recited in claim 17 further including a shaft supported in the reservoir along the central axis, and the wheel being mounted for rotation about the shaft.

20. The wheel apparatus recited in claim 17 further comprising:
a. a first elongated rod extending between first and second opposing ends, the first elongated rod extending generally diametrically through the wheel and being slidingly supported by the wheel;
b. a first of the plurality of float members being coupled to the first end of the first elongated rod; and
c. a second of the plurality of float members being coupled to the second end of the first elongated rod.

21. The wheel apparatus recited in claim 17 wherein the liquid in the reservoir has an upper surface, and wherein each of the plurality of float members extends at least partially through the upper surface of the liquid when each such float member is disposed directly above the central axis.

22. The wheel apparatus recited in claim 17 further including a second fixed electromagnet positioned generally above the wheel and having the same magnetic polarity as the plurality of float members for repelling each float member as each float member rotates past the second fixed electro-magnet, and urging each passing float member to move radially inward.
